(19) United States
(12) Patent Application Publication
(10) Pub. No.: US 2025/0129259 A1
(43) Pub. Date: Apr. 24, 2025

(54) INK SET FOR INKJET TEXTILE PRINTING, IMAGE FORMING METHOD, AND IMAGE FORMED PRODUCT

(71) Applicant: Konica Minolta, Inc., Tokyo (JP)

(72) Inventor: Fumiaki KOBAYASHI, Tokyo (JP)

(21) Appl. No.: 18/896,311

(22) Filed: Sep. 25, 2024

(30) Foreign Application Priority Data
Oct. 19, 2023 (JP) 2023-180181

(51) Int. Cl. C09D 11/40; C09D 11/107; C09D 11/38; C09D 11/54; D06P 1/54; D06P 5/00; D06P 5/30

(52) U.S. Cl. CPC C09D 11/40; C09D 11/107; C09D 11/38; C09D 11/54; D06P 1/54; D06P 5/002; D06P 5/30

(57) ABSTRACT

An ink set for inkjet textile printing includes an ink and at least one treatment liquid. The ink includes a pigment, a pigment-dispersing agent, and a solvent, the pigment-dispersing agent is a block copolymer including a hydrophilic block A and a hydrophobic block B, at least one of the treatment liquid and the ink contains a crosslinking agent, and the crosslinking agent includes at least one of a vinyl ether compound, an epoxy compound, a carbodiimide compound, an oxazoline compound, an isocyanate compound, and an aziridine compound.

### CROSS REFERENCE TO RELATED APPLICATIONS

The entire disclosure of Japanese Patent Application No. 2023-180181 filed on Oct. 19, 2023, is incorporated herein by reference in its entirety.

### BACKGROUND

### Technological Field

The present invention relates to an ink set for inkjet textile printing, an image forming method, and an image formed product.

### Description of Related Art

As a method of forming an image on a fabric such as a fabric or a nonwoven fabric, there are a screen printing method, a roller printing method, and the like. In recent years, inkjet textile printing in which an image is formed on a fabric by an inkjet method has been widely used because dyeing can be performed in a short time and production efficiency is high.

Coloring materials for textile printing ink include dyes and pigments. An ink using a dye has, in addition to excellent color development, an advantage of high color fastness because the ink is dyed by utilizing a reaction with a functional group of a fiber. On the other hand, processing operations such as a steaming step for fixing the dye and a step of removing an unfixed portion of the dye are required, and the burden of these operations is a problem.

On the other hand, an ink using a pigment is preferred to that using a dye for its simplicity, because not only an image having high light fastness can be formed, but also a treatment operation such as a step of removing an unfixed dye is unnecessary. Addition of a crosslinking agent to the ink has been studied from the viewpoint of improving the fastness of an image.

Japanese Unexamined Patent Publication No. 2022-148532 discloses, as an aqueous inkjet printing ink composition for textile printing containing a pigment, for example, a composition containing a pigment, a random copolymer as a pigment-dispersing agent, and a crosslinking agent.

In addition, Japanese Unexamined Patent Publication No. 2020-204115 discloses a manufacturing method in which an inkjet ink composition containing pigments and crosslinkable binder components is inkjet-printed on a textile to obtain a printed material, and then the printed material is heat-treated with water vapor. Japanese Unexamined Patent Publication No. 2020-204115 describes that a printed body is heat-treated with water vapor to melt or soften a crosslinkable binder component and to crosslink the crosslinkable binder component to form a film.

On the other hand, Japanese Unexamined Patent Publication No. 2016-210921 describes an ink composition for inkjet textile printing containing a pigment, an A-B block polymer in which A and B are polymerization polymers of different monomers as a polymer dispersant, and a urethane resin, and describes a configuration not containing a crosslinking agent in Examples.

According to the findings of the present inventors, in Japanese Unexamined Patent Publication No. 2022-148532, the improvement of fastness has been studied by using inks containing random copolymers as pigment-dispersing agents and crosslinking agents, but the fastness of images has been insufficient. In addition, the image quality deteriorates due to the influence of the crosslinking agent, and the image quality is unsatisfactory.

Further, in Japanese Unexamined Patent Publication No. 2020-204115, since the crosslinkable binder components are crosslinked by the crosslinking agent in the image portion formed on the fabric to form a film, the image quality is deteriorated by the influence of the crosslinking agent, and the texture is also insufficient.

On the other hand, in Japanese Unexamined Patent Publication No. 2016-210921, the fastness is improved by adding a urethane resin as a binder component, but the fastness of the image is insufficient. When the present inventors used a crosslinking agent in combination, it was difficult to increase the fastness, and an attempt to increase the fastness resulted in an insufficient texture, and it was not possible to achieve both the fastness and the texture.

### SUMMARY

The present invention has been devised in view of such circumstances. The present invention provides an ink set for inkjet textile printing, which is excellent in texture, wet friction color fastness, and washing fastness even when the amount of a binder component is small, and gives satisfactory image quality, and provides an image forming method and an image formed product.

In order to achieve at least one of the abovementioned objects, an ink set for inkjet textile printing reflecting one aspect of the present invention.

### DETAILED DESCRIPTION OF EMBODIMENTS

The advantageous and features provided by one or more embodiments of the invention will become more fully understood from the detailed description given hereinbelow, and thus are not intended as a definition of the limits of the present invention:

Hereinafter, one or more embodiments of the present invention will be described. However, the scope of the invention is not limited to the disclosed embodiments.

Note that in the present specification, a numerical range indicated by using “to” means a range including numerical values described before and after “to” as a lower limit value and an upper limit value.

### 1. Ink Set for Inkjet Textile Printing

An ink set for inkjet textile printing according to one embodiment of the present invention includes an inkjet ink (hereinafter, referred to as “ink”) and at least one treatment liquid. Furthermore, at least one of the ink and the treatment liquid contains a crosslinking agent.

In particular, the treatment liquid applied before the ink is applied is also referred to as a “pretreatment liquid”, and the treatment liquid applied after the ink is applied is also referred to as a “post-treatment liquid”.

### 1-1. Crosslinking Agent

The ink set for inkjet textile printing according to an embodiment of the present invention includes a crosslinking agent. The crosslinking agent includes at least one compound selected from the group consisting of vinyl ether compound, epoxy compound, carbodiimide compound, oxazoline compound, isocyanate compound, and aziridine compound.

The crosslinking agent reacts with a hydrophilic functional group (a hydroxyl group, a carboxyl group, an amino group, a sulfonic acid group, or the like) that has a hydrogen atom bonded to a nitrogen atom or an oxygen atom, of a pigment-dispersing agent described later or fabric. Thus, the swelling of the image portion with water is suppressed, and the wet friction color fastness and the washing fastness are improved.

The crosslinking agent may be synthesized using a known technique, or a commercially available product may be used. Examples of the crosslinking agent include the crosslinking agents described in paragraphs 0130 and 0235 of Japanese Unexamined Patent Publication No. 2020-2220 and paragraphs 0066 to 0073 of Japanese Unexamined Patent Publication No. 2020-203965.

Examples of the vinyl ether compound include 1,4-butanediol divinyl ether, ethylene glycol divinyl ether, diethylene glycol divinyl ether, triethylene glycol divinyl ether, polyethylene glycol divinyl ether, propylene glycol divinyl ether, butyleneglycol divinyl ether, hexanediol divinyl ether, trimethylolethane trivinyl ether, trimethylolpropane trivinyl ether, ditrimethylolpropane tetravinyl ether, glycerin trivinyl ether, pentaerythritol tetravinyl ether, dipentaerythritol pentavinyl ether, and dipentaerythritol hexavinyl ether.

Examples of the epoxy compound include ethylene glycol diglycidyl ether, polyethylene glycol diglycidyl ether, 1,6-hexanediol diglycidyl ether, diethylene glycol diglycidyl ether, dipropylene glycol diglycidyl ether, polypropylene glycol diglycidyl ether, and trimethylolpropane triglycidyl ether. Examples of the commercially available product include Denacol series manufactured by Nagase ChemteX Corporation.

Examples of the carbodiimide compound include carbodiimide, N,N′-dimethylcarbodiimide, N-ethyl, N′-isopropylcarbodiimide, N,N′-diisopropylcarbodiimide, N,N′-dicyclohexylcarbodiimide, N,N′-diphenylcarbodiimide, N,N′-diacetylcarbodiimide, N,N′-bis(2-propene)-carbodiimide, N,N′-dipyrrolidylcarbodiimide, N,N′-diethoxycarbodiimide, bis(trimethylsilyl) carbodiimide, 1-cyclohexyl-3-(2-morpholinoethyl) carbodiimide metho-p-toluene sulfonate, 1-ethyl-3-(3-dimethylaminopropyl) carbodiimide hydrochloride, calcium cyanamide, and polymers each having a carbodiimide structure in the main chain or side chain thereof. Examples of commercially available products include Carbodilite manufactured by Nisshinbo Chemical Inc.

Examples of the oxazoline compounds include 2-oxazoline, 2-methyl-2-oxazoline, 2-ethyl-2-oxazoline, 2-(n-propyl)-2-oxazoline, 2-(isopropyl)-2-oxazoline, 2-cyclohexyl-2-oxazoline, 2-phenyl-2-oxazoline, 2-pyrrolidyl-2-oxazoline, 2-acetyl-2-oxazoline, 2-(2-propene)-2-oxazoline, 4,5-dimethyl-2-oxazoline, 2,4,4-trimethyl-2-oxazoline, 5-phenyl-2-(2-propynylamino)-2-oxazolin-4-one, 4-ethoxymethylene-2-phenyl-2-oxazolin-5-one, and polymers each having an oxazoline structure in the in the main chain or side chain thereof. Examples of the commercially available product include EPOCROS series manufactured by Nippon Shokubai Co., Ltd.

Examples of the isocyanate compound include phenylene diisocyanate, cyclohexane diisocyanate, tolylene diisocyanate, xylylene diisocyanate, diphenylmethane diisocyanate, naphthalene diisocyanate, hexamethylene diisocyanate, trimethylhexamethylene diisocyanate, isophorone diisocyanate, dicyclohexylmethane diisocyanate, bis(isocyanatomethyl) cyclohexane, norbornene diisocyanate, lysine diisocyanate, multimers of the aforementioned diisocyanates, and reaction products of one mole of a diol and two moles of a diisocyanate. In addition, in order to enhance stability in a solvent containing water, a blocked isocyanate stabilized by masking an isocyanate group with a blocking agent is preferably used. Examples of commercially available products of the blocked isocyanate include Meikanate series manufactured by Meisei Chemical Works, Ltd.

Examples of the aziridine compound include trimethylolpropane-tri-β-aziridinyl propionate, tetramethylolmethane-tri-β-aziridinyl propionate, N,N′-diphenylmethane-4,4′-bis(1-aziridine carbonamide), N,N′-hexamethylene-1,6′-bis(1-aziridine carboxamide), and N,N′-toluene-2,4′-bis(1-aziridine carbonamide). Examples of commercially available products include the Chemitight series manufactured by Nippon Shokubai Co., Ltd.

In addition, among the crosslinking agents, an epoxy compound, an oxazoline compound, and an isocyanate compound are preferable from the viewpoint of improving storage stability and wet friction color fastness. From the viewpoint of improving image quality in addition to storage stability and wet friction color fastness, an epoxy compound and an isocyanate compound are more preferable. An isocyanate compound is more preferable from the viewpoint of improving texture in addition to storage stability, wet friction color fastness, and image quality. The epoxy compound and the isocyanate compound not only form a crosslinked structure with the pigment-dispersing agent, but also favorably crosslink with a hydrophilic functional group contained in the fabric. Therefore, the moisture-heat fastness is further enhanced. Furthermore, the epoxy compound and the isocyanate compound have high affinity for an additive, such as an aggregating agent, contained in the ink and are less likely to prevent wetting and spreading of the ink. Therefore, concentration unevenness of the pigment can be suppressed, and image quality is improved.

In a case where the crosslinking agent is included in the treatment liquid, the content of the crosslinking agent is preferably from 0.1% by mass to 4.0% by mass, and more preferably from 0.5% by mass to 2.0% by mass, with respect to the total mass of the treatment liquid. When the content is 0.1% by mass or more, a crosslinked structure is sufficiently formed, and thus the wet friction color fastness can be improved. When the content is 4.0% by mass or less, both wet friction color fastness and texture can be achieved.

The crosslinking agent may be contained in the ink, may be contained in the treatment liquid, or may be contained in both the ink and the treatment liquid. When the crosslinking agent is contained in the treatment liquid, the crosslinking agent may be contained in the pretreatment liquid or the post-treatment liquid, or may be contained in both of them.

The crosslinking agent is preferably contained in the pretreatment liquid and/or the ink, and more preferably contained in the ink, from the viewpoint of efficiently promoting a crosslinking reaction with a pigment-dispersing agent and enhancing wet friction color fastness.

Further, from the viewpoint of enhancing the storage stability of the ink, the crosslinking agent is preferably contained in the treatment liquid, and more preferably contained in the pretreatment liquid.

When a crosslinking agent is contained in the ink, it is preferable for crosslinking between the hydrophobic sites of the dispersion. The content of the crosslinking agent in the ink is preferably 5% by mass to 1000% by mass, and more preferably 10% by mass to 100% by mass, with respect to the total mass of the pigment-dispersing agent. The content of the crosslinking agent in the ink is more preferably 25% by mass to 100% by mass, and most preferably 25% by mass to 50% by mass, with respect to the total mass of the pigment-dispersing agent. When the content is 5% by mass or more, the crosslinking agent can be sufficiently crosslinked with the pigment-dispersing agent. When the content is 1000% by mass or less, both abrasion resistance and texture can be achieved.

From the viewpoint of enhancing the storage stability of the ink, the content of the crosslinking agent with respect to the total mass of the ink is preferably 3.0% by mass or less, more preferably 2.0% by mass or less, even more preferably 1.0% by mass or less, and most preferably 0.1% by mass or less.

Regarding the relative relationship between the content of the crosslinking agent in the treatment liquid and the content of the crosslinking agent in the ink, the content of the crosslinking agent based on the total mass of the treatment liquid is preferably greater than the content of the crosslinking agent based on the total mass of the ink. Thus, the storage stability of the ink can be enhanced while enhancing the wet friction color fastness and the washing fastness.

### 1-2. Inkjet Ink

An ink according to the present embodiment contains a pigment, a pigment-dispersing agent, and a solvent.

### 1-2-1. Pigment

The pigment contained in the ink is not particularly limited, but is preferably, for example, an organic pigment or an inorganic pigment having the following number described in the Color Index.

Examples of orange pigments include Pigment Orange31 and 43.

Examples of red or magenta pigments include Pigment Red 3, 5, 19, 22, 31, 38, 43, 48:1, 48:2, 48:3, 48:4, 48:5, 49:1, 53:1, 57:1, 57:2, 58:4, 63:1, 81, 81:1, 81:2, 81:3, 81:4, 88, 104, 108, 112, 122, 123, 144, 146, 149, 166, 168, 169, 170, 177, 178, 179, 184, 185, 208, 216, 226, 257, Pigment Violet 3, 19, 23, 29, 30, 37, 50, 88, and Pigment Orange 13, 16, 20, 36.

Examples of blue or cyan pigments include Pigment Blue 1, 15, 15:1, 15:2, 15:3, 15:4, 15:6, 16, 17-1, 22, 27, 28, 29, 36, 60.

Examples of green or yellow pigments include Pigment Green 7, 26, 36, 50. Examples of yellow pigments include Pigment Yellow 1, 3, 12, 13, 14, 15, 17, 34, 35, 37, 55, 74, 81, 83, 93, 94, 95, 97, 108, 109, 110, 128, 137, 138, 139, 151, 153, 154, 155, 157, 166, 167, 168, 180, 185, 193, and 213.

Examples of black pigments include Pigment Black 7, 28, and 26.

Commercial examples of pigments include:
Chromofine Yellow 2080, 5900, 5930, AF-1300, 2700L, Chromofine Orange 3700L, 6730, Chromofine Scarlet 6750, Chromofine Magenta 6880, 6886, 6891N, 6790, 6887, Chromofine Violet RE, Chromofine Red 6820, 6830, Chromofine Blue HS-3, 5187, 5108, 5197, 5085N, SR-5020, 5026, 5050, 4920, 4927, 4937, 4824, 4933GN-EP, 4940, 4973, 5205, 5208, 5214, 5221, 5000P, Chromofine Green 2GN, 2GO, 2G-550D, 5310, 5370, 6830, Chromofine Black A-1103, Seikafast Yellow 10GH, A-3, 2035, 2054, 2200, 2270, 2300, 2400 (B), 2500, 2600, ZAY-260, 2700 (B), 2770, Seikafast Red 8040, C405 (F), CA120, LR-116, 1531B, 8060R, 1547, ZAW-262, 1537B, GY, 4R-4016, 3820, 3891, ZA-215, Seikafast Carmine 6B1476T-7, 1483LT, 3840, 3870, Seikafast Bordeaux 10B-430, Seikalight Rose R40, Seikalight violet B800, 7805, Seikafast Maroon 460N, Seikafast Orange 900, 2900, Seikalight Blue C718, A612, and Cyanine Blue 4933M, 4933GN-EP, 4940, 4973 (Manufactured by Dainichi Seika Chemical Industry Co., Ltd.);
KET Yellow 401, 402, 403, 404, 405, 406, 416, and 424, KET Orange 501, KET Red 301, 302, 303, 304, 305, 306, 307, 308, 309, 310, 336, 337, 338, and 346, KET Blue 101, 102, 103, 104, 105, 106, 111, 118, 124, and KET Green 201 (manufactured by Dainippon Ink and Chemicals, Inc);
Colortex Yellow 301, 314, 315, 316, P-624, 314, U10GN, U3GN, UNN, UA-414, U263, Finecol Yellow T-13, T-05, Pigment Yellow 1705, Colortex Orange 202, Colortex Red 101, 103, 115, 116, D3B, P-625, 102, H-1024, 105C, UFN, UCN, UBN, U3BN, URN, UGN, UG276, U456, U457, 105C, USN, Colortex Maroon 601, Colortex Brown B610N, Colortex Violet 600, Pigment Red 122, ColortexBlue 516, 517, 518, 519, A818, P-908, 510, Colortex Green 402, 403, and Colortex Black 702 and U905 (manufactured by Sanyo Shikiso Co., Ltd);
Lionol Yellow 1405G, Lionol Blue FG7330, FG7350, FG7400G, FG7405G, ES, ESP-S (manufactured by Toyo Ink Mfg. Co., Ltd), Toner Magenta E02, Permanent Rubin F6B, Toner Yellow HG, Permanent Yellow GG-02, Hostapeam Blue B2G (manufactured by Hoechst Industries, Ltd);
Novoperm P-HG, Hostaperm Pink E, Hostaperm Blue B2G (manufactured by Clariant);
Carbon black #2600, #2400, #2350, #2200, #1000, #990, #980, #970, #960, #950, #850, MCF88, #750, #650, MA600, MA7, MA8, MA11, MA100, MA100R, MA77, #52, #50, #47, #45, #45L, #40, #33, #32, #30, #25, #20, #10, #5, #44, and CF9 (manufactured by Mitsubishi Chemical Corporation); and
REGAL (registered trademark) 250R, 330, 330R, 350R, 400, 400R, 660, and 660R (manufactured by Cabot Corporation).

The pigment is preferably further dispersed with a pigment-dispersing agent from the viewpoint of enhancing the dispersibility in the ink. The pigment-dispersing agent will be described later.

The pigment may be a self-dispersible pigment. The self-dispersible pigment is obtained by modifying the surface of a pigment particle with a group having a hydrophilic group, and has a pigment particle and a group having hydrophilicity bonded to the surface of the pigment particle. Examples of the hydrophilic group include a carboxy group, a sulfonic acid group, and a phosphorus-containing group. Examples of the phosphorus-containing group include a phosphoric acid group, a phosphonic acid group, a phosphinic acid group, a phosphite group, and a phosphate group.

Commercial examples of self-dispersible pigments include Cab-0-Jet (registered trademark) 200K, 250C, 260M, 270V (sulfonic acid group-containing self-dispersible pigments), Cab-0-Jet (registered trademark) 300K (carboxylic acid group-containing self-dispersible pigments), Cab-0-Jet (registered trademark) 400K, 450C, 465M, 470V, 480V (phosphoric acid group-containing self-dispersible pigments) from Cabot Corporation.

The content of the pigment is not particularly limited, but is preferably from 0.3 to 12% by mass and more preferably from 0.5 to 8% by mass with respect to the ink from the viewpoints of easily adjusting the viscosity of the ink to a range described later and forming an image with a higher density. When the content of the pigment is 0.3% by mass or more, the color of the obtained image is more likely to be vivid, and when the content is 12% by mass or less, the viscosity of the ink does not become excessively high, and therefore, the ejection stability is less likely to be impaired.

### 1-2-2. Pigment-Dispersing Agent

The pigment-dispersing agent is a block copolymer including a hydrophilic block A and a hydrophobic block B.

The hydrophilic block A includes a site (hereinafter, referred to as a “hydrophilic site”) which enhances the affinity with the aqueous solvent contained in the ink and interacts or reacts with the aggregating agent attached to the fabric, and is a block having a higher affinity with water among the blocks constituting the copolymer.

The hydrophobic block B is a site adsorbing to the pigment (hereinafter, referred to as a “hydrophobic site”), and refers to a block having a smaller affinity with the aqueous solvent contained in the ink among the blocks constituting the copolymer.

A conventionally used pigment-dispersing agent is a random copolymer randomly including a hydrophilic site and a hydrophobic site. Since the random copolymer randomly includes a hydrophobic site, the random copolymer cannot be continuously bonded to the pigment, and the copolymer is easily peeled off from the pigment by a shearing force due to the circulation of the ink. Therefore, even when the pigment-dispersing agent is crosslinked with a crosslinking agent, it has been difficult to enhance the fastness of the image formed product. However, when a block copolymer is used as the pigment-dispersing agent, the pigment-dispersing agent is less likely to be detached from the pigment, and the wet friction color fastness and the washing fastness of the image formed product can be further enhanced by crosslinking of the pigment-dispersing agent and the crosslinking agent.

Furthermore, since the block copolymer can make the pigment dispersion in the ink less likely to cause bridging aggregation while maintaining dispersibility in an aqueous solvent, the storage stability, the ejection stability, and the image quality are improved. In addition, since the aggregation of the pigment-dispersing agent in the ink can be suppressed, the pigment-dispersing agent is uniformly applied to the surface of the fabric even in the fabric after the application of the ink. Therefore, a local reaction is less likely to occur due to a crosslinking reaction with the crosslinking agent, and the texture of the cloth is more likely to be maintained without causing local texture deterioration.

The number of each of the hydrophilic blocks A and the hydrophobic blocks B contained in one molecule of the block copolymer may be one, or maybe two or more. That is, when the hydrophilic block is A and the hydrophobic block is B, examples of the structure of the block copolymer include an ABA type, an ABABA type, and the like. In particular, an ABA-type block copolymer including two hydrophilic blocks A disposed at both ends of the molecule and a hydrophobic block B disposed between the hydrophilic blocks A and having a lower affinity for an aqueous solvent than the hydrophilic blocks A is more preferable. Since the ABA-type block copolymer has two hydrophilic sites at both ends of the molecule, there are many bonding points which interact or react with the crosslinking agent and/or the aggregating agent attached to the fabric, and the washing fastness and the rubbing fastness are easily enhanced. In addition, since the ABA-type block copolymer can be intermittently bonded in a plurality of blocks, the fabric is less likely to become hard and the texture of the cloth is more likely to be maintained, as compared with an AB-type block copolymer in which bonding is continuously performed in one block.

The types and composition ratios of the monomers of the plurality of blocks A included in the block copolymer may be the same as or different from each other. In addition, in a case where the block copolymer includes a plurality of blocks A, the types and composition ratios of the monomers of the plurality of blocks A may be the same as or different from each other.

The hydrophilic block A and the hydrophobic block B are each described below.

The hydrophilic block A includes a constituent unit derived from a monomer having a hydrophilic group (hereinafter, referred to as a “hydrophilic monomer”). Examples of the hydrophilic functional group include a hydroxyl group, a carboxyl group, an amino group, a ketone group, a sulfonic acid group, and an oxyalkylene group of an alkylene oxide-modified product. From the viewpoint of crosslinking reaction with the crosslinking agent, and the examples include at least one functional group having a hydrogen atom bonded to a nitrogen atom or an oxygen atom (a hydroxyl group, a carboxyl group, an amino group, a sulfonic acid group, and the like).

Examples of the hydrophilic monomer constituting the hydrophilic block A include a monomer containing a carboxyl group or an acid anhydride group, a monomer containing a sulfonic acid group, and an ethylene oxide-modified (meth)acrylic acid ester monomer. Examples of the monomer containing a carboxyl group or an acid anhydride group include unsaturated polyvalent carboxylic acids such as (meth)acrylic acid and maleic acid, monomers containing a carboxyl group or an acid anhydride such as maleic anhydride, and the like. Examples of the monomer containing a sulfonic acid group include styrenesulfonic acid and 4-(methacryloyloxy) butylsulfonic acid. Examples of the ethylene oxide-modified (meth)acrylic acid ester monomer include ethylene oxide-modified (meth)acrylic acid alkyl ester. Of these, the hydrophilic monomer is preferably (meth)acrylic acid from the viewpoint of imparting moderate water solubility to the hydrophilic block A.

The content ratio of a constituent unit derived from a hydrophilic monomer in the hydrophilic block A is greater than the content ratio of a constituent unit derived from a hydrophilic monomer in the hydrophobic block B. Specifically, the content ratio of the constituent unit derived from a hydrophilic monomer in the hydrophilic block A is preferably 10% by mass or more with respect to the total mass of the hydrophilic block A. When the content ratio of the hydrophilic monomer in the hydrophilic block A is 10% by mass or more, the dispersibility in an aqueous solvent is more easily enhanced. From the same viewpoint, the content ratio is more preferably 15% by mass to 80% by mass.

The content ratio of a constituent unit derived from a hydrophilic monomer in the hydrophobic block B is less than the content ratio of a constituent unit derived from a hydrophilic monomer in the hydrophilic block A. For example, in a case where the block copolymer includes two hydrophilic blocks A and one hydrophobic block B, the content of the constituent unit derived from the hydrophilic monomer in the hydrophobic block B is smaller than that in either of the two hydrophilic blocks A. Specifically, the content of the constituent unit derived from a hydrophilic monomer in the hydrophobic block B is less than 10% by mass and preferably 5% by mass or less with respect to the hydrophobic block B.

The hydrophilic block A may further include a constituent unit derived from another monomer other than the hydrophilic monomer. Examples of other monomers include methyl (meth)acrylate, (meth)acrylic acid alkyl esters such as (meth)acrylic acid tert-butyl ester; and monomers containing an aromatic ring group or an alicyclic hydrocarbon group described below.

The content of the hydrophobic block B in the ABA-type block copolymer is preferably 10% by mass to 80% by mass, and more preferably 20% by mass to 80% by mass, with respect to the entire block copolymer. When the content is 10% by mass or more, since the content of the hydrophilic block A is small (or the molecular weight is small), bridged aggregation is more easily suppressed. In addition, when the content is 80% by mass or less, since the content of the hydrophilic block A is large (or the molecular weight is large), the affinity for an aqueous solvent is more easily enhanced.

The content of the hydrophilic block A is preferably 150% by mass or less with respect to the content of the hydrophobic block B. As a result, the length per hydrophilic block A can be appropriately shortened, and bridging aggregation can be made less likely to occur.

The hydrophobic block B preferably contains a constituent unit derived from a monomer having a hydrophobic functional group (hereinafter, referred to as a “hydrophobic monomer”). Examples of the monomer having a hydrophobic functional group include monomers containing an aromatic ring group or an alicyclic hydrocarbon group.

Examples of the monomer having an aromatic ring group include benzyl (meth)acrylate; phenyl (meth)acrylate; (meth)acrylates having an aromatic ring group such as phenoxyethyl (meth)acrylate; aromatic monomers such as styrene, α-methylstyrene, 4-methylstyrene, 2-methylstyrene, 3-methylstyrene, 4-methoxystyrene, 2-hydroxymethylstyrene and 1-vinylnaphthalene; and the like, and monomers having an aromatic ring group having 6 to 15 carbon atoms are preferable.

Examples of the monomer having an alicyclic alkyl group include cyclohexyl (meth)acrylate; methylcyclohexyl (meth)acrylate; cyclododecyl (meth)acrylate; bornyl (meth)acrylate; isobornyl (meth)acrylate; dicyclopentanyl (meth)acrylate; (meth)acrylates having an alicyclic alkyl group such as dicyclopentenyl (meth)acrylate and dicyclopentenyloxyethyl (meth)acrylate; and the like, and a monomer having an alicyclic alkyl group having 6 to 15 carbon atoms is preferable.

Of these, from the viewpoint of improving the adsorptivity to a pigment, the hydrophobic monomer is preferably a monomer having an aromatic ring group having 6 to 15 carbon atoms, such as benzyl (meth)acrylate.

The content ratio of the constituent unit derived from the hydrophobic monomer in the hydrophobic block B is preferably 10% by mass or more based on the hydrophobic block B. When the content ratio is 10% by mass or more, the adsorptivity to a pigment is more likely to be increased. From the same viewpoint, the content ratio is more preferably 15% by mass to 100% by mass.

The hydrophobic block B may further include a constituent unit derived from another monomer other than the hydrophobic monomer. Examples of other monomers include the aforementioned alkyl (meth)acrylates and the aforementioned hydrophilic monomers.

From the viewpoint of further enhancing the dispersibility of the pigment, the molecular weight distribution (PDI)) (weight average molecular weight (Mw) of the block copolymer)/(number average molecular weight (Mn) of the block copolymer) is preferably 2.0 or less. The weight average molecular weight (Mw) and the number average molecular weight (Mn) can be determined by gel permeation chromatography (GPC).

The weight average molecular weight of the block copolymer is preferably 7000 to 21000, and more preferably 10,000 to 20000. When the weight average molecular weight is 7000 or more, the dispersibility of the pigment in an aqueous solvent is easily enhanced. When the molecular weight is 21000 or less, a bonding point which interacts or reacts with the crosslinking agent and/or the aggregating agent attached to the fabric does not become too long. Therefore, the pigment-dispersing agent and the crosslinking agent and/or the flocculating agent can be intermittently bonded, and the fabric is less likely to become hard and the texture is more likely to be enhanced. The weight average molecular weight of the block copolymer can be measured by the same method as described above.

The acid number of the block copolymers is, for example, preferably 40 mgKOH/g to 400 mgKOH/g, more preferably 40 mgKOH/g to 300 mgKOH/g, and even more preferably 40 mgKOH/g to 190 mgKOH/g. When the acid value is 40 mgKOH/g or more, the hydrophilicity of the pigment-dispersing agent can be increased to further increase the dispersibility of the pigment. In addition, when the acid number is 400 mgKOH/g or less, the hydrophilicity of the pigment-dispersing agent can be further suppressed from being excessively increased, and the water resistance of the obtained image formed product can be further increased. The acid number can be measured in accordance with a JIS K0070 1992 measurement method.

The content of the block copolymer is preferably 5% by mass to 90% by mass, more preferably 15% by mass to 80% by mass, with respect to the pigment. When the content is 5% by mass or more, the dispersibility of the pigment in an aqueous solvent can be further enhanced. When the content is 90% by mass or less, it is possible to further suppress an excessive increase in the viscosity of the water-based ink due to excessive inclusion of the block copolymer.

The method for synthesizing the block copolymer is not particularly limited, and for example, the block copolymer can be obtained by sequentially subjecting monomers constituting the block to a polymerization reaction by a living radical polymerization method.

### 1-2-3. Solvent

The solvent contains water, and preferably further contains a water-soluble organic solvent. A solvent containing water is also referred to as a “water-based solvent”, and an ink containing a water-based solvent is also referred to as a “water-based ink” or an “aqueous ink”.

The content of the water is from 20 to 70% by mass, and preferably from 30 to 60% by mass, with respect to the ink.

The water-soluble organic solvent is not particularly limited as long as it is compatible with water, but it is preferable that the ink does not easily thicken due to drying, from the viewpoint of making it easy for the ink to permeate into the inside of the fabric, and from the viewpoint of making it difficult for the ejection stability in the inkjet system to be impaired. Therefore, the ink preferably contains a high-boiling-point solvent having a boiling point of 200° C. or more.

The high-boiling-point solvent having a boiling point of 200° C. or higher may be any water-soluble organic solvent having a boiling point of 200° C. or higher, and is preferably a polyol or a polyalkylene oxide.

Examples of the polyols having a boiling point of 200° C. or higher include dihydric alcohols and trihydric or higher-hydric alcohols. Examples of the dihydric alcohols include 1,3-butanediol (boiling point 208° C.), 1,6-hexanediol (boiling point 223° C.), and polypropylene glycol. Examples of the trihydric or higher hydric alcohols include glycerin (boiling point 290° C.) and trimethylolpropane (boiling point 295° C.).

Examples of the polyalkylene oxides having a boiling point of 200° C. or higher include diethylene glycol monoethyl ether (boiling point 202° C.), triethylene glycol monomethyl ether (boiling point 245° C.), tetraethylene glycol monomethyl ether (boiling point 305° C.), tripropylene glycol monoethyl ether (boiling point 256° C.), ethers of dihydric alcohols such as polypropylene glycol, and ethers of trihydric or higher hydric alcohols such as glycerin (boiling point 290° C.) and hexanetriol.

The solvent may further include another solvent in addition to the high-boiling-point solvent. Examples of the other solvents include polyhydric alcohols having a boiling point of lower than 200° C. (e.g., ethyleneglycol, propyleneglycol, and hexanetriol); polyhydric alcohol ethers having a boiling point of lower than 200° C. (e.g., ethyleneglycol monomethyl ether, ethyleneglycol monobutyl ether, diethyleneglycol monomethyl ether, diethyleneglycol dimethyl ether, propyleneglycol monomethyl ether, and propyleneglycol monoethyl ether); monohydric alcohols (e.g., methanol, ethanol, propanol, pentanol, hexanol, cyclohexanol, and benzyl alcohols); amines (e.g., ethanol amine, N-ethyldiethanolamine, morpholine, N-ethylmorpholine, ethylene diamine, diethylene diamine, and triethylene tetramine); amides (e.g., formaldehyde, N,N-dimethylformamide, and N,N-dimethylacetamide); heterocycles (e.g., 2-pyrrolidone, N-methyl-2-pyrrolidone, N-cyclohexyl-2-pyrrolidone, 2-oxazolidone, and 1,3-dimethyl-2-imidazolidine); sulfoxides (e.g., dimethylsulfoxide); and sulfones (e.g., sulfolane).

The content of the water-soluble organic solvent is from 20 to 70% by mass, preferably from 30 to 60% by mass, with respect to the ink. When the content is 20% by mass or more, thickening due to drying can be suppressed. When the content is 70% by mass or less, the solvent drying time after application of the ink to a fabric or the like becomes too long.

### 1-2-4. Other Components

The ink may further contain components other than those described above, as necessary. Examples of the other components include additives such as a neutralizer, a softener, a lubricant, a surfactant, a preservative, a pH adjustor, and a water-dispersible resin as a binder component.

### (Water-Dispersible Resin)

The water-dispersible resin can have a function of fixing the pigment or the like to the fabric. The water-dispersible resin may be contained in the ink as resin particles.

Examples of the water-dispersible resin include a urethane resin, a butadiene resin, a (meth)acrylic resin, and polystyrene. Examples of the butadiene resin include a styrene-butadiene copolymer and an acrylonitrile-butadiene copolymer. Examples of the (meth)acrylic resin include a (meth)acrylic acid ester copolymer, a styrene-(meth)acrylic copolymer, a silicone-(meth)acrylic copolymer, and an acrylic-modified fluorine resin. Among these, urethane resins; and (meth)acrylic ester copolymers and styrene-(meth)acrylic copolymers as (meth)acrylic resins are preferable. It is presumed that these are bonded to the block copolymer by an intermolecular hydrogen bond, easily increase the adhesiveness of the pigment to the fabric, and easily increase the color fastness to rubbing.

Examples of the styrene-(meth)acrylic copolymer include a styrene-(meth)acrylic acid copolymer and a styrene-(meth)acrylic acid-(meth)acrylic acid ester copolymer. Examples of the (meth)acrylic ester include benzyl (meth)acrylate, cyclohexyl (meth)acrylate, methyl (meth)acrylate, ethyl (meth)acrylate, propyl (meth)acrylate, butyl (meth)acrylate, hexyl (meth)acrylate, octyl (meth)acrylate, lauryl (meth)acrylate, 2-ethylhexyl (meth)acrylate, 2-ethylhexylcarbitol (meth)acrylate, phenol EO-modified (meth)acrylate, isobornyl (meth)acrylate, dicyclopentenyl (meth)acrylate, dicyclopentanyl (meth)acrylate, and dicyclopentenyloxyethyl (meth)acrylate.

The urethane resin is a polymer obtained by reacting a polyol with a polyisocyanate. Examples of polyols include polypropylene glycol, polyethylene glycol, polytetramethylene glycol, poly(ethylene adipate), poly(diethylene adipate), poly(propylene adipate), poly(tetramethylene adipate), poly(hexamethylene adipate), poly-ε-caprolactone, poly(hexamethylene carbonate), and silicone polyols. Examples of the isocyanate include tolylene diisocyanate, 4,4-diphenylmethane diisocyanate, xylylene diisocyanate, naphthalene diisocyanate, hexamethylene diisocyanate, hydrogenated tolylene diisocyanate, hydrogenated 4,4-diphenylmethane diisocyanate, isophorone diisocyanate, and xylylene diisocyanate.

The Tg of the water-dispersible resin is not particularly limited, but is preferably low from the viewpoint that the fabric is less likely to become hard even after image formation and the texture is easily maintained. The Tg of the water-dispersible resin may be, for example, −30 to 100° C., and preferably −10 to 50° C.

The acid value of the water-dispersible resin is not particularly limited, but is preferably 44 mgKOH/g or more, and more preferably 60 mgKOH/g or more, for example, from the viewpoint of enhancing dispersion stability. The upper limit of the acid number may be, for example, 110 mgKOH/g. The acid value can be measured by the same method as described above.

The mean particle diameter of the water-dispersible polymer is not particularly limited, but is preferably 300 nm or less, and more preferably 130 nm or less, from the viewpoint of suppressing nozzle clogging of an inkjet head. The mean particle diameter of the water-dispersible resin can be measured by laser diffraction scattering particle size distribution measurement.

The content of the water-dispersible resin is preferably from 0 to 15% by mass, more preferably from 0 to 7% by mass, more preferably from 0 to 3% by mass, and most preferably from 0 to 2% by mass, with respect to the ink. Setting the content of the water-dispersible resin to 7% by mass or less with respect to the ink reduces the likelihood of filter clogging in a circulation type inkjet ink head and enhances ejection stability. In addition, ink droplets easily wet and spread, and image quality is improved.

### (Additives)

Examples of the additives include neutralizers, softeners, lubricants, surfactants, preservatives, antifungal agents, and pH adjusters.

In the present embodiment, when the block copolymer has an anionic group such as a carboxy group or a sulfonic acid group, the ink may further contain a neutralizer. As the neutralizer, a known basic compound can be used, and for example, sodium hydroxide, potassium hydroxide, ammonia, triethylamine, and the like can be used. Inclusion of a neutralizer in the pigment dispersion can moderately promote dissociation of the anionic group in the pigment dispersion and further enhance the dispersibility.

The content of the neutralizer is not particularly limited, but the neutralizer is preferably contained such that an amount that the neutralization rate is 30% or more and 100% or less. The neutralization rate can be determined by the following formula (1).

Neutralization rate (%)=(weight of basic compound [g]/(equivalents of basic compound [g/mol]×of basic compound))÷((acid number of pigment-dispersing agent [mgKOH/g]weight of×pigment-dispersing agent [g])/(56 [g/mol]×1000)) (1).

As the softener, a known softener can be used. Examples of the lubricant include silicone-based emulsion, diethylene glycol, and wax.

The wax can be selected from natural waxes such as animal-based waxes, plant-based waxes, petroleum-based waxes, and mineral-based waxes, and synthetic waxes. Examples of commercially available waxes include AQUACER manufactured by BYK Japan KK, JONCRYL WAX26J manufactured by BASF Japan, and the like.

The surfactant can lower the surface tension of the ink and increase the wettability of the ink to the fabric. The type of surfactant is not particularly limited, and may be, for example, an acetylene glycol-based surfactant, a silicone-based surfactant, or a fluorine-based surfactant. Examples of commercially available acetylene glycol-based surfactants include Olfine series manufactured by Nissin Chemical Industry Co., Ltd

Examples of the preservatives or antifungal agent include aromatic halogen compounds (e.g., Preventol CMK), methylene dithiocyanate, halogen-containing nitrogen-sulfur compounds, 1,2-benzisothiazolin-3-one (e.g., PROXEL GXL), and the like.

Examples of pH adjusters include citric acid, sodium citrate, hydrochloric acid, sodium hydroxide, and the like.

### 1-2-5. Physical Properties of Ink

The viscosity of the ink of the present invention at 25° C. is not particularly limited as long as the ejection properties by an inkjet method become satisfactory, but is preferably in the range of 3 to 20 mPa·s, and more preferably in the range of 4 to 12 mPa·s. The viscosity of the ink can be measured at 25° C. using an E-type viscometer.

### 1-3. Treatment Liquid

The treatment liquid preferably contains an aggregating agent from the viewpoint of improving image quality.

### 1-3-1. Aggregating Agent

The type of the aggregating agent is not particularly limited as long as the aggregating agent aggregates the pigment or the like contained in the ink. The aggregation may be carried out using a change in pH or using an electrical action.

Examples of the aggregating agent that causes aggregation by a change in pH include organic acids. Examples of the organic acid include carboxylic acids having 6 or less carbon atoms, such as saturated fatty acids (e.g., formic acid, acetic acid, propionic acid, butyric acid, valeric acid, and hexanoic acid) and hydroxy acids (e.g., lactic acid, malic acid, and citric acid).

Examples of the aggregating agent that causes aggregation by an electrical action include a compound having an ionic group and a polyvalent metal salt.

In a case of applying the aggregating agent to the pretreatment liquid, the aggregating agent is preferably a compound having an ionic group paired with a pigment-dispersing agent contained in the ink. That is, in a case where the pigment-dispersing agent is an anionic compound, it is preferable to use a compound having a cationic group as the aggregating agent to be added to the pretreatment liquid, since the pigment-dispersing agent and the aggregating agent can interact or react with each other.

In addition, an aspect in which two or more types of aggregating agents are used is also preferably used. In this case, by using two treatment liquids and adding a compound having an ionic group that forms a pair with the ionic group provided in the first treatment liquid to the second treatment liquid, the aggregating agent provided in the first treatment liquid and the aggregating agent provided in the second treatment liquid interact or react with each other after image formation. Therefore, the electrostatic repulsion between the aggregating agents applied to the first treatment liquid is suppressed, the aggregation property of the pigment or the like is increased, and the water resistance of the image formed product is improved. Specifically, it is preferable that the aggregating agent applied to the first treatment liquid has an anionic group and the aggregating agent applied to the second treatment liquid has a cationic property; or the aggregating agent applied to the first treatment liquid has a cationic group and the aggregating agent applied to the second treatment liquid has an anionic group. In particular, when the pigment-dispersing agent contained in the ink is an anionic compound, it is preferable to use the first treatment liquid as the pretreatment liquid to apply the compound having a cationic group and use the second treatment liquid as the post-treatment liquid to apply the compound having an anionic group.

The aggregating agent may be contained in the pretreatment liquid or the post-treatment liquid, but is preferably contained in the pretreatment liquid from the viewpoint of improving image quality.

Examples of the cationic group in the compound having a cationic group include a secondary amino group, a tertiary amino group, and a quaternary ammonium salt group. Examples of the compound having a cationic group include cationic resins and cationic surfactants, with cationic resins being preferred.

Examples of the cationic resin include a cationic urethane resin, a cationic olefin resin, and a cationic alkylamine resin. Examples of commercially available products include MPT-60 manufactured by Mitsubishi Pencil Co., Ltd., Unisence KHE100L manufactured by Senka Corporation, and urethane resin MZ477 manufactured by Takamatsu Oil & Fat Co., Ltd. Among these, cationic alkylamine resins MPT-60 and Unisence KHE100L are preferable from the viewpoint of more easily causing an interaction or a reaction with the block copolymer.

Examples of the anionic resin include a (meth)acrylic resin, a urethane resin, a polyolefin resin, a polyester resin, a polyvinyl chloride resin, an epoxy resin, a polysiloxane resin, a fluorine resin, a styrene copolymer, and a vinyl acetate copolymer. The anionic resin can be appropriately selected from the above examples. Examples of the polyvinyl chloride resin include a polyvinyl chloride polymer and a vinyl chloride-vinylidene chloride copolymer. Examples of the styrene copolymer include a styrene-butadiene copolymer and a styrene-(meth)acrylate copolymer. Examples of the vinyl acetate copolymer include an ethylene-vinyl acetate copolymer. From the viewpoint of further enhancing the water resistance of the formed image, the anionic resin is preferably selected from (meth)acrylic resin, urethane resin, polyolefin resin, polyvinyl chloride resin, epoxy resin, polysiloxane resin, fluororesin, styrene copolymer, vinyl acetate copolymer, and the like. The anionic resin is preferably selected from urethane resin and (meth)acrylic resin. Examples of commercially available products that may be used include EMN-325E manufactured by Nippon Shokubai Co., Ltd., HA-207 manufactured by Nicca Chemical Co., Ltd., a-1127 manufactured by Kusumoto Chemicals, Ltd, and Aniset Series manufactured by Osaka Organic Chemical Industry Ltd.

The polyvalent metal salt may be a water-soluble compound having a divalent or more polyvalent metal ion and an anion to be bonded thereto. Examples of the polyvalent metal ion include divalent metal ions such as Ca²⁺, Cu²⁺, Ni²⁺, Mg²⁺, Zn²⁺, and Ba²⁺; and trivalent metal ions such as Al³⁺, Fe³⁺, and Cr³⁺. Examples of the anion include Cl⁻, I⁻, Br⁻, SO₄²⁻, ClO₃⁻, NO₃⁻, HCOO⁻, and CH₃COO⁻. Examples of such polyvalent metal salts include zinc acetate dihydrate, magnesium nitrate, calcium salts such as calcium chloride, magnesium chloride, aluminum chloride, magnesium sulfate, and acetic acid, and metal salts of organic acids such as magnesium salts, nickel salts, and aluminum salts. Among these, calcium salts and magnesium salts are preferable, and calcium nitrates and calcium chlorides are preferable.

Among these, a compound having a cationic group or an organic acid is preferable, and a compound having a cationic group is more preferable.

The content of the aggregating agent in the treatment liquid is not particularly limited, but is preferably 0.1 to 15% by mass and more preferably 0.5 to 10% by mass with respect to the pretreatment liquid.

### 1-3-2. Other Components

The treatment liquid may further include additives such as a solvent, a surfactant, a pH adjuster, and a preservative, as necessary. The same solvents, surfactants, pH adjusters, and preservatives as those used in the ink can be used.

### 2. Image Forming Method

An image formed product according to an embodiment of the present invention can be produced through a step of applying the treatment liquid and a step of applying the ink by an inkjet method. The step of applying the treatment liquid may be provided before the step of applying the ink or after the step of applying the ink.

### 2-1. Step of Applying Ink

In this step, the ink is applied onto the fabric by an inkjet method. The fabric may be a fabric subjected to a step of applying a treatment liquid.

The type of fiber included in the fabric is not particularly limited, and examples thereof include natural fibers such as cotton (cellulose fiber), hemp, wool, and silk; chemical fibers such as rayon, vinylon, nylon, acryl, polyurethane, polyester, and acetate; and mixed spun fibers thereof. Of these, cotton fabric is preferred. The fabric may be any form of these fibers, such as a woven fabric, a nonwoven fabric, and a knitted fabric. Furthermore, the fabric may be a blended woven fabric or a blended nonwoven fabric of two or more types of fibers.

In the present embodiment, the ink contains a block copolymer as a pigment-dispersing agent. The block copolymer is less likely to cause bridging aggregation with another pigment-dispersing agent than the random copolymer. Thus, the aggregation of the pigment dispersion is easily suppressed, and high ejection stability is obtained.

### 2-2. Step of Applying Treatment Liquid

In this step, the treatment liquid is applied onto the fabric. The fabric may be a fabric that has undergone the step of applying ink.

The method of applying the treatment liquid is not particularly limited, and may be, for example, a pad method, a coating method, a spraying method, or an inkjet method. Among these, an inkjet method is preferable from the viewpoint of increasing production efficiency.

The fabric contacted with the treatment liquid may be heated and dried by using warm air, a hot plate, or a heat roller.

The amount of the treatment liquid to be applied is not particularly limited, and can be adjusted according to the type of fabric, the amount of the ink to be applied, and the like.

In particular, when the treatment liquid contains a crosslinking agent, the application amount of the treatment liquid is preferably adjusted so that the ratio X1/Y1 between the amount X1 g/m² of the crosslinking agent to be applied to the fabric and the amount Y1 g/m² of the pigment-dispersing agent to be applied to the fabric is in the range of 0.05 to 10.0, more preferably 0.10 to 5.0, still more preferably 0.10 to 1.0, and most preferably 0.10 to 0.50. When X1/Y1 is 0.05 or more, the crosslinking agent can sufficiently form a crosslinked structure with the pigment dispersion agent, and the wet fastness to rubbing can be enhanced. In addition, when X1/Y1 is 10.0 or less, the crosslinking agent does not excessively react, the texture can be maintained, and both the texture and the wet friction color fastness can be achieved. When X1/Y1 is 1.0 or less, both the texture and the wet friction color fastness can be more readily achieved. When X1/Y1 is 0.50 or less, both the texture and the wet friction color fastness can be further more easily achieved.

### 3. Image-Formed Product

The obtained image formed product includes a fabric and an image portion. The image portion contains a pigment and a pigment-dispersing agent crosslinked by a crosslinking agent.

When an ABA-type block copolymer is used as the pigment-dispersing agent, the block copolymer can be bonded to the fabric at a plurality of bonding points including two bonding points located at both ends of the molecule. Therefore, the pigment can be excellently adhered to the fabric as compared with a conventional AB type block copolymer that is bonded to the fabric at only one molecular end. Thus, the image formed product has high washing fastness and high friction fastness. Furthermore, since the ABA-type block copolymer is bonded to the fabric at a plurality of positions, the fabric is less likely to be hardened than a conventional AB-type block copolymer which is bonded to the fabric at only one position.

A ratio X2/Y2, namely a ratio between an application amount X2 g/m² of the crosslinking agent contained in the image portion and an application amount Y2 g/m² of the pigment-dispersing agent contained in the image portion, is preferably in a range of 0.05 to 10.0. Furthermore, X2/Y2 is more preferably adjusted to be in a range of 0.10 to 5.0, even more preferably adjusted to be in a range of 0.10 to 1.0, and most preferably adjusted to be in a range of 0.10 to 0.50. When X2/Y2 is 0.05 or more, the crosslinking agent can sufficiently form a crosslinked structure with the pigment dispersion agent. The crosslinking agent can sufficiently form a crosslinked structure with the pigment dispersion agent. In addition, when X2/Y2 is 10.0 or less, the crosslinking agent does not excessively react, the texture can be maintained, and both the texture and the wet friction color fastness can be achieved. When X2/Y2 is 1.0 or less, both the texture and the wet friction color fastness can be further more readily achieved. By setting X2/Y2 to be 0.50 or less, both the texture and the wet friction color fastness can be further readily achieved.

The application amounts of the crosslinking agent and the pigment-dispersing agent contained in the image portion are measured by the ATR-method (Attenuated Total Reflection, total-reflection measurement method) using FT-IR Magna 860-NIC plan IR-Microscope manufactured by Nicolet Co., Ltd. The application amount of the pigment-dispersing agent can be confirmed by comparing the peak intensity of 1650-1800 cm⁻¹ derived from the pigment-dispersing agent in the obtained FT-IR spectrum with the peak intensity of an image portion in which the application amount of the pigment-dispersing agent is a known amount. Further, the application amount of the crosslinking agent contained in the image portion can be confirmed by comparing the peak intensity at a value corresponding to the compound as follows with the peak intensity of an image portion having a known amount of crosslinking agent: when the compound is a vinyl ether compound, the peak intensity is 1600-1700 cm⁻¹, when the compound is an epoxy compound, the peak intensity is 850-950 cm⁻¹, when the compound is a carbodiimide compound, the peak intensity is 2100-2200 cm⁻¹, when the compound is an oxazoline compound, the peak intensity is 1650-1750 cm⁻¹, when the compound is an isocyanate compound, the peak intensity is 2200-2300 cm⁻¹, when the compound is an aziridine compound, the peak intensity is 1300-1400 cm⁻¹.

### EXAMPLES

Hereinafter, the present invention will be specifically described with reference to Examples, but the present invention is not limited thereto. Note that in the following Examples, operations were performed at room temperature (25° C.) unless otherwise specified. Further, unless otherwise specified, “%” and “part(s)” mean “% by mass” and “part(s) by mass”, respectively.

### 1 Preparation of Pretreatment Liquid

### 1-1. Preparation of Pretreatment Liquid

### <Preparation of Pretreatment Liquid 1-1>

The following components were mixed to prepare a pretreatment liquid 1-1.

Composition of pretreatment liquid 1-1

| | | |
|---|---|---|
| MPT-60 (cationic resin, manufactured by | 6.8 | parts by mass |
| Mitsubishi Pencil Co., Ltd): | | |
| Triethylene glycol divinyl ether (vinyl ether- | 0.50 | parts by mass |
| based crosslinking agent, manufactured by Tokyo | | |
| Chemical Industry Co., Ltd.): | | |
| Ethylene glycol (solvent): | 20 | parts by mass |
| Propylene glycol (solvent): | 10 | parts by mass |
| Olfine E1010 (surfactant, manufactured by Nissin | 0.1 | parts by mass |
| Chemical Industry Co., Ltd.): | | |
| Proxel GXL (S) (preservative, manufactured by | 0.5 | parts by mass |
| Lonza): | | |

Ion exchanged water: 62.1 parts by mass

### <Preparation of Pretreatment Liquids 1-2 to 1-9>

Pretreatment solutions 1-2 to 1-9 were prepared in the same manner except that the type and content of the crosslinking agent were changed as listed in Table 1, and the amount of ion exchanged water was adjusted such that the total amount became 100 parts by mass.

The compositions of the pretreatment liquids 1-1 to 1-9 are listed in Table 1.

TABLE 1

| | | pretreat- | pretreat- | pretreat- | pretreat- | pretreat- | pretreat- | pretreat- | pretreat- | pretreat- |
|---|---|---|---|---|---|---|---|---|---|---|
| | | ment | ment | ment | ment | ment | ment | ment | ment | ment |
| Material | | liquid 1-1 | liquid 1-2 | liquid 1-3 | liquid 1-4 | liquid 1-5 | liquid 1-6 | liquid 1-7 | liquid 1-8 | liquid 1-9 |
| Resin | MPT-60 | 6.8% | 6.8% | 6.8% | 6.8% | 6.8% | 6.8% | 6.8% | 6.8% | 6.8% |
| Crosslinking | Triethylene glycol | 0.50% | | | | | | | | |
| agent | Divinyl ether | | | | | | | | | |
| | Denacol | | 0.50% | | | | | 3.00% | | |
| | EX-313 | | | | | | | | | |
| | Carbodilite | | | 0.50% | | | | | | |
| | (registered | | | | | | | | | |
| | trademark) V-02 | | | | | | | | | |
| | WS-700 | | | | 0.50% | | | | | |
| | Meikanate CX | | | | | 0.50% | | | 3.00% | |
| | DZ-22E | | | | | | 0.50% | | | |
| Organic | Ethylene glycol | 20% | 20% | 20% | 20% | 20% | 20% | 20% | 20% | 20% |
| solvent | | | | | | | | | | |
| Organic | Propylene glycol | 10% | 10% | 10% | 10% | 10% | 10% | 10% | 10% | 10% |
| solvent | | | | | | | | | | |
| Surfactant | Olfine E1010 | 0.10% | 0.10% | 0.10% | 0.10% | 0.10% | 0.10% | 0.10% | 0.10% | 0.10% |
| Preservative | Proxel | 0.50% | 0.50% | 0.50% | 0.50% | 0.50% | 0.50% | 0.50% | 0.50% | 0.50% |
| | GXL(S) | | | | | | | | | |
| Water | Ion exchanged | 62.1% | 62.1% | 62.1% | 62.1% | 62.1% | 62.1% | 59.6% | 59.6% | 62.6% |
| | water | | | | | | | | | |

| | | | | | | | | | |
|---|---|---|---|---|---|---|---|---|---|
| Total | 100% | 100% | 100% | 100% | 100% | 100% | 100% | 100% | 100% |

### (Crosslinking Agent)

Denacol EX-313: epoxy-based crosslinking agent manufactured by Nagase ChemteX Corporation
Carbodilite (registered trademark) V-02: carbodiimide-based crosslinking agent, manufactured by Nisshinbo Chemical Inc.
WS-700: oxazoline-based crosslinking agent, manufactured by Nippon Shokubai Co., Ltd
Meikanate CX: isocyanate-based crosslinking agent, manufactured by Meisei Chemical Industry Co., Ltd
DZ-22E: aziridine-based crosslinking agent, manufactured by Nippon Shokubai Co., Ltd

### 2. Preparation of Ink

### 2-1. Preparation of Copolymer (Pigment-Dispersing Agent)

### <Preparation of Block Copolymer P-1 (ABA-Type)>

A reaction vessel equipped with a stirrer, a reflux condenser, a thermometer, and a nitrogen inlet tube was charged with tripropylene glycol monomethyl ether (207 parts by mass), benzyl methacrylate (hereinafter referred to as “BzMA”) (17.6 parts by mass), 2-ethylhexyl methacrylate (hereinafter referred to as “2EHMA”) (29.7 parts by mass), methacrylic acid (hereinafter referred to as “MAA”) (1.0 part by mass), iodine (2.0 parts by mass), 2,2′-azobis(4-methoxy-2,4-dimethylvaleronitrile) (hereinafter referred to as “AMDV”) (4.0 parts by mass), and diphenylmethane (hereinafter referred to as “DPM”) (0.08 parts by mass). Polymerization was carried out at 40° C. for 5 hours to obtain polymer chain B which would become a hydrophobic block.

To the reaction liquid, cyclohexyl methacrylate (hereinafter referred to as “CHMA”) (25.2 parts by mass), methyl methacrylate (hereinafter referred to as “MMA”) (10.0 parts by mass), and MAA (8.6 parts by mass) were added. Thereafter, polymerization was performed for 3 hours to form a polymer chain A1 serving as a hydrophilic block, thereby obtaining an AB-type block copolymer composed of the polymer chain A1 and the polymer chain B.

BzMA (4.3 parts by mass) and MAA (8.6 parts by mass) were added thereto, and polymerized for 2 hours to form a polymer chain A2 serving as a hydrophilic block, thereby obtaining an ABA-type block copolymer consisting of the polymer chain A1, the polymer chain B, and the polymer chain A2.

After cooling to room temperature, a homogenized aqueous solution of sodium hydroxide (8.0 parts by mass) and ion exchanged water (199 parts by mass) was added for neutralization. Ion exchanged water was added to adjust the solid content, thereby obtaining an aqueous solution of an ABA-type block copolymer having a solid content of 30%. The obtained block copolymer had a weight average molecular weight of 12000, a PDI of 1.36, and an acid number of 113 mgKOH/g.

### <Preparation of Block Copolymer P-2 (AB Type)>

In a glove box purged with nitrogen, a flask equipped with a stirrer was charged with BzMA (90 g, 511 mmol), ethyl-2-methyl-2-n-butyltellanyl-propionate (hereinafter referred to as “BTEE”) (2.00 g, 6.67 mmol) as a polymerization initiator, dibutyl ditelluride (hereinafter referred to as “DBDT”) (1.22 g, 3.33 mmol), 2,2′-azobis-isobutyronitrile (manufactured by Otsuka Chemical Co., Ltd., hereinafter referred to as “AIBN”) (0.33 g, 2.00 mmol), and methoxypropanol (90 g), and the mixture was allowed to react at 60° C. for 16 hours.

Butyl methacrylate (hereinafter, referred to as “n-BMA”) (45 g, 317 mmol), MAAs (25 g, 290 mmol), AIBN (0.22 g, 1.33 mmol), and methoxypropanol (70 g) were added to the reactant, and the mixture was allowed to react at 60° C. for 22 hours. In this way, the polymer chain A was formed.

After completion of the reaction, the reaction solution was poured into 5L heptane, and the precipitate was collected by suction filtration and dried to obtain a block copolymer in the form of a white powder. Thereafter, a homogenized aqueous solution of sodium hydroxide (8.0 parts by mass) and ion exchanged water (199 parts by mass) was added for neutralization. Ion exchanged water was added to adjust the solid content, thereby obtaining an aqueous solution of an AB type block copolymer having a solid content of 30%. The obtained block copolymer had a weight average molecular weight of 11000, a PDI of 1.49, and an acid number of 104 mgKOH/g.

### <Preparation of Random Copolymer P-3>

Ion exchanged water (100 parts by mass) was placed in a reaction vessel equipped with a dropping device, a thermometer, a water-cooled reflux condenser, and a stirrer, ammonium persulfate (0.4 parts by mass) as a polymerization initiator was added under stirring at 70° C. in a nitrogen atmosphere, and a monomer solution containing styrene (70 parts by mass), methyl acrylate (19 parts by mass), MMA (31 parts by mass), and N-butyl acrylate (20 parts by mass) was added dropwise to the reaction vessel to cause a reaction, thereby causing polymerization to prepare a polymer. Thereafter, the mixture was filtered through a 0.3-μm filter, and the solid content was adjusted by adding ion exchanged water to obtain resin particles in an emulsion state having a solid content of 30%. The weight average molecular weight of the obtained random copolymer was 8800.

### <Preparation of Block Copolymer P-4 (ABA Type)>

An aqueous solution of block copolymer P-4 was obtained in the same manner as in the preparation of block copolymer P-1, except that the amount of AMDV was changed from 4.0 parts by mass to 1.6 parts by mass. The obtained block copolymer had a weight average molecular weight of 30000, a PDI of 1.69, and an acid value of 113 mgKOH/g.

### 2-2. Preparation of Pigment Dispersion

### <Preparation of Pigment Dispersion A-1>

A 30% solids aqueous solution (45.0 parts by mass) of block copolymer P-1 (pigment-dispersing agent), propylene glycol (20 parts by mass), and ion exchanged water (17.0 parts by mass) were added to REGAL330R (black pigment, manufactured by Cabot Corporation) (18.0 parts by mass) and mixed. Thereafter, the mixture was dispersed using a sand grinder filled with 50 vol % of zirconia beads having a mean particle diameter of 0.5 mm to prepare a pigment dispersion A-1 in which the content of the pigment was 18.0% by mass.

### <Preparation of Pigment Dispersions A-2, A-3, and A-4>

Pigment dispersions A-2, A-3, and A-4 were prepared in the same manner except that the type of the copolymer (pigment-dispersing agent) was changed as illustrated in Table 2.

TABLE 2

| Pigment dispersion | Copolymer (Pigment- |
|---|---|
| No. | dispersing agent) |
| A-1 | P-1 |
| A-2 | P-2 |
| A-3 | P-3 |
| A-4 | P-4 |

### 2-3. Preparation of Ink

### <Preparation of Ink 2-1>

The following components were mixed to obtain ink 2-1.

Composition of ink 2-1

| | | |
|---|---|---|
| Pigment dispersion A-1 (pigment concentration | 10 | parts by mass |
| 18.0% by mass): | | |
| Glycerin: | 10 | parts by mass |
| Ethylene glycol: | 25 | parts by mass |
| Proxel GXL (S) (preservative, manufactured by | 0.1 | parts by mass |
| Lonza): | | |
| Sodium Citrate Hydrate (pH-adjuster): | 2.0 | parts by mass |

| | |
|---|---|
| Ion exchanged water: | Remaining amount |

Note that the ion exchanged water was adjusted so that the total amount of the ink would be 100 parts by mass.

### <Preparation of Inks 2-2 to 2-32>

The inks 2-2 to 2-32 were prepared in the same manner as the ink 2-1 except that the type of the pigment dispersion, the type and the added amount of the crosslinking agent, and the type and the added amount of the binder component were changed as illustrated in Table 3, and the added amount of the ion exchanged water was adjusted such that the total amount became 100 parts by mass.

TABLE 3

| | | Crosslinking agent | | Binder component | |
|---|---|---|---|---|---|
| | | | Added | | Added |
| | Pigment | | amount | | amount |
| Ink | dispersion | | [% by | | [% by |
| No. | No. | Type | mass] | Type | mass] |
| 2-1 | A-1 | — | — | — | — |
| 2-2 | A-2 | — | — | — | — |
| 2-3 | A-3 | — | — | — | — |
| 2-4 | A-4 | — | — | — | — |
| 2-5 | A-3 | Triethylene glycol | 0.50% | — | — |
| | | Divinyl ether | | | |
| 2-6 | A-3 | Denacol | 0.50% | — | — |
| | | EX-313 | | | |
| 2-7 | A-3 | Carbodilite | 0.50% | — | — |
| | | (registered | | | |
| | | trademark) V-02 | | | |
| 2-8 | A-3 | WS-700 | 0.50% | — | — |
| 2-9 | A-3 | Meikanate CX | 0.50% | — | — |
| 2-10 | A-3 | DZ-22E | 0.50% | — | — |
| 2-11 | A-3 | Denacol | 3.00% | — | — |
| | | EX-313 | | | |
| 2-12 | A-3 | Meikanate CX | 3.00% | — | — |
| 2-13 | A-2 | Triethylene glycol | 0.50% | — | — |
| | | Divinyl ether | | | |
| 2-14 | A-2 | Denacol | 0.50% | — | — |
| | | EX-313 | | | |
| 2-15 | A-2 | Carbodilite | 0.50% | — | — |
| | | (registered | | | |
| | | trademark) V-02 | | | |
| 2-16 | A-2 | WS-700 | 0.50% | — | — |
| 2-17 | A-2 | Meikanate CX | 0.50% | — | — |
| 2-18 | A-2 | DZ-22E | 0.50% | — | — |
| 2-19 | A-1 | Triethylene glycol | 0.50% | — | — |
| | | Divinyl ether | | | |
| 2-20 | A-1 | denacol EX-313 | 0.50% | — | — |
| 2-21 | A-1 | Carbodilite | 0.50% | — | — |
| | | (registered | | | |
| | | trademark) V-02 | | | |
| 2-22 | A-1 | WS-700 | 0.50% | — | — |
| 2-23 | A-1 | Meikanate CX | 0.50% | — | — |
| 2-24 | A-1 | DZ-22E | 0.50% | — | — |
| 2-25 | A-2 | Meikanate CX | 3.00% | — | — |
| 2-26 | A-1 | Meikanate CX | 3.00% | — | — |
| 2-27 | A-3 | — | — | Superflex 300 | 8.0% |
| 2-28 | A-3 | — | — | Superflex 300 | 8.0% |
| 2-29 | A-2 | — | — | Superflex 300 | 8.0% |
| 2-30 | A-2 | — | — | Superflex 300 | 8.0% |
| 2-31 | A-1 | — | — | Superflex 300 | 8.0% |
| 2-32 | A-1 | — | — | Superflex 300 | 8.0% |

### (Binder)

Superflex 300: manufactured by Dai-ichi Kogyo Seiyaku Co

### 3. Preparation of Post-Treatment Liquid

### 3-1. Preparation of Post-Treatment Liquid

### <Preparation of Post-Treatment Liquid 3-1>

The following components were mixed to prepare post-treatment liquid 3-1.

The viscosity of the completed post-treatment liquid 3-1 at 25° C. was 4.8 mPa·s.

Composition of post-treatment liquid 3-1

| | | |
|---|---|---|
| HA-207 (anionic urethane resin, manufactured by | 10 | parts by mass |
| Nicca Chemical Co., Ltd): | | |
| Ethylene glycol (solvent): | 20 | parts by mass |
| Glycerin (solvent): | 10 | parts by mass |
| Olfine E1010 (surfactant, manufactured by | 0.10 | parts by mass |
| Nissin Chemical Industry Co., Ltd.): | | |
| Proxel GXL (S) (preservative, manufactured by | 0.05 | parts by mass |
| Lonza): | | |
| Ion exchanged water: | 59.85 | parts by mass |

### 4. Image Formation and Evaluation

### 4-1. Image Formation

### <Test 1: Preparation of Image Formed Product Including Fabric and Image Portion Disposed on Fabric>

The pretreatment liquid 1-1, the ink 2-3, and the post-treatment liquid 3-1 prepared above were set in a simple printing tester equipped with a KM1024i head as an inkjet head.

As a fabric, Cotton Broad 40 (100% cotton) was prepared. The pretreatment liquid, the ink, and the post-treatment liquid were applied to the surface of the fabric in the following order of steps using the simple printing tester to form an image. The pretreatment liquid, the ink, and the post-treatment liquid were applied in a wet-on-wet manner. In addition, all of these applications were performed by the main scanning 540 dpi×the sub-scanning 720 dpi using an inkjet method and a multi-pass method. The “dpi” stands for the number of ink droplets (dots) per 2.54 cm. The ejection frequency was set to 22.4 kHz. The image to be formed was an image including a fine line grid, gradation, and a solid portion (200 mm×200 mm as a whole).

First, the pretreatment liquid 1-1 was applied at an application amount of 30 g/m². Next, the voltage was adjusted to apply the ink 2-3 so as to have an application amount of 3.75 g/m². Next, the post-treatment liquid 3-1 was applied so as to have an application amount of 3.75 g/m². The step of applying the ink and the post-treatment liquid was repeated so that the applied ink and post-treatment liquid overlaid with each other, and the ink and the post-treatment liquid were applied eight times each.

Thereafter, the fabric was dried at 130° C. for 10 minutes to obtain an image formed product including the fabric and the image portion disposed on the fabric.

### <Test 1: Preparation of Image Formed Product Including Coated Paper and Image Portion Disposed on Coated Paper>

A solid image was formed in the same manner as above using the same simple printing tester as above, except that the printing method was a printing width of 100 nm×100 nm, a resolution of 720 dpi×720 dpi, and the printing substrate was coated paper (OK Topcoat, Oji Paper Co., Ltd.).

Thereafter, the coated paper was dried at 75° C. for 10 minutes to obtain an image formed product including the coated paper and an image portion disposed on the coated paper.

### <Tests 2 to 51>

Image formation was performed in the same manner as in Test 1, except that at least one of the type of the pretreatment liquid and the type of the ink was changed as shown in Tables 4 and 5, to obtain an image formed product including a fabric and an image portion disposed on the fabric, and an image formed product including a coated paper and an image portion disposed on the coated paper.

### 4-2. Evaluation

The following evaluations are performed on the obtained image formed product. Among the following, image quality, texture, wet friction color fastness, and washing fastness were evaluated for an image formed product including a fabric and an image portion disposed on the fabric. On the other hand, the fixability was evaluated for coated paper and an image formed product including an image portion disposed on the coated paper.

### (Image Quality)

The solid quality of the entire solid image formed was visually observed and evaluated according to the following criteria. C or better was accepted.

A: The image was a uniform image without density unevenness, and was a satisfactory image in which ink omission was not observed.

B: The image was a practically acceptable image in which although there are places with different shading, no ink omission is observed.

C: In the image, there is a portion where the ink is dropped, and a slight void is generated.

D: In the image, there are many portions where ink has dropped out, and the image has conspicuous white spots.

### (Fixability)

A tape peeling test by cross-cutting was performed on the formed solid image. Next, the fixability of the image was evaluated according to the following criteria. A to D were determined to be satisfactory.

A: The area of the image peeled off by the tape is less than 1% with respect to an area of the solid image.

B: The area of the image peeled off by the tape is 1% or more and less than 3% with respect to the area of the solid image.

C: The area of the image peeled off by the tape is 3% or more and less than 5% with respect to the area of the solid image.

D: The area of the image peeled off by the tape is 5% or more and less than 10% with respect to the area of the solid image.

E: The area of the image peeled off by the tape is 10% or more with respect to the area of the solid image.

### (Texture)

The texture of the obtained image formed product and the cloth was sensuously evaluated by touching with fingers. The evaluation was performed based on the following criteria. When it was A or higher, it was accepted.

∘: The original softness of the cloth is maintained, and the texture of the cloth is not changed or is hardly changed as compared with that before the image formation.

Δ: Although the fabric was slightly harder than before the image formation, the texture of the cloth was not impaired, and the fabric was at a practically acceptable level.

x: As compared with before image formation, the fabric became harder and the texture of the cloth was impaired, which is a level causing a practical problem.

### (Wet Friction Color Fastness)

The wet friction color fastness of the obtained image formed product was evaluated with a crockmeter (friction tester type I) according to JIS L 0849. Specifically, the image on the surface of the image formed product was captured with a scanner, subjected to image processing, and the contamination level of the white fabric was quantified and evaluated according to the following criteria. An evaluation of 3 or higher was accepted.

5: The staining of the white fabric is improved by 90% or more compared to the case where the post-treatment is not performed.

4: The staining of the white fabric is improved by 60% or more and less than 90% compared to the case where the post-treatment is not performed.

3: The staining of the white fabric is improved by 30% or more and less than 60% compared to the case where the post-treatment is not performed.

2: The staining of the white fabric is improved by 10% or more and less than 30% compared to the case where the post-treatment is not performed.

1: The staining of the white fabric is improved by less than 10% as compared with the case where the post-treatment is not performed.

### (Washing Fastness)

The washing fastness of the image formed product was evaluated by comparing an image formed product which had been washed once with a household washing machine (washed with water) with an image formed product which had not been washed, and evaluating color loss. Then, evaluation was performed based on the following evaluation criteria. When it was A or higher, it was accepted.

⊚: There is no color loss after rinsing with water.

∘: The color loss after rinsing with water was slight or almost none, and was at a level of no problem in practical use.

Δ: There is some color loss after rinsing with water, but at a level not posing a practical problem.

x: The color loss after rinsing with water was significant, which was a level causing a practical problem.

Tables 4 and 5 show the results of evaluation of the image formed products of Tests 1 to 51.

TABLE 4

| | Pretreat- | | | Application amount | | | | | | | |
|---|---|---|---|---|---|---|---|---|---|---|---|
| | ment | | | Y1 of pigment- | | Evaluation | | | | | |
| | liquid | | Application amount | dispersing agent | | | | | Wet | | |
| | Pretreat- | Ink | X1 of crosslinking | (block copolymer) | | | | | friction | | |
| Test | ment | Ink | agent per unit | per unit area | | Image | Fixabil- | Tex- | color | Washing | |
| No. | liquid No. | No. | area [g/m²] | [g/m²] | X1/Y1 | quality | ity | ture | fastness | fastness | Remarks |
| 1 | 1-1 | 2-3 | 0.15 | 0 | — | D | E | Δ | 1 | x | Comparative example |
| 2 | 1-2 | | 0.15 | 0 | — | D | C | Δ | 2 | x | Comparative example |
| 3 | 1-3 | | 0.15 | 0 | — | D | D | Δ | 1 | x | Comparative example |
| 4 | 1-4 | | 0.15 | 0 | — | D | D | ∘ | 2 | x | Comparative example |
| 5 | 1-5 | | 0.15 | 0 | — | D | D | ∘ | 2 | x | Comparative example |
| 6 | 1-6 | | 0.15 | 0 | — | D | E | Δ | 1 | x | Comparative example |
| 7 | 1-7 | | 0.90 | 0 | — | D | A | x | 2 | x | Comparative example |
| 8 | 1-8 | | 0.90 | 0 | — | D | B | x | 2 | x | Comparative example |
| 9 | 1-1 | 2-2 | 0.15 | 0.405 | 0.37 | C | C | Δ | 3 | Δ | [Example] |
| 10 | 1-2 | | 0.15 | 0.405 | 0.37 | B | A | Δ | 5 | ∘ | Example |
| 11 | 1-3 | | 0.15 | 0.405 | 0.37 | C | B | ∘ | 3 | ∘ | Example |
| 12 | 1-4 | | 0.15 | 0.405 | 0.37 | C | B | ∘ | 4 | Δ | Example |
| 13 | 1-5 | | 0.15 | 0.405 | 0.37 | B | A | ∘ | 4 | ∘ | Example |
| 14 | 1-6 | | 0.15 | 0.405 | 0.37 | B | C | Δ | 3 | Δ | Example |
| 15 | 1-1 | 2-1 | 0.15 | 0.405 | 0.37 | B | B | Δ | 4 | Δ | Example |
| 16 | 1-2 | | 0.15 | 0.405 | 0.37 | A | A | Δ | 5 | ∘ | Example |
| 17 | 1-3 | | 0.15 | 0.405 | 0.37 | B | A | ∘ | 4 | ∘ | Example |
| 18 | 1-4 | | 0.15 | 0.405 | 0.37 | B | A | ∘ | 5 | ∘ | Example |
| 19 | 1-5 | | 0.15 | 0.405 | 0.37 | A | A | ∘ | 5 | ∘ | Example |
| 20 | 1-6 | | 0.15 | 0.405 | 0.37 | B | B | Δ | 4 | Δ | Example |
| 21 | 1-8 | 2-2 | 0.90 | 0.405 | 2.22 | A | A | Δ | 5 | ∘ | Example |
| 22 | 1-8 | 2-1 | 0.90 | 0.405 | 2.22 | A | A | Δ | 5 | ∘ | Example |
| 23 | 1-5 | 2-4 | 0.15 | 0.405 | 0.37 | A | A | Δ | 5 | ∘ | Example |

TABLE 5

| | Pretreat- | | | Application amount | | | | | | | |
|---|---|---|---|---|---|---|---|---|---|---|---|
| | ment | | | Y1 of pigment- | | | | | | | |
| | liquid | | Application amount | dispersing agent | | Evaluation | | | | | |
| | Pretreat- | Ink | X1 of crosslinking | (block copolymer) | | | | | Wet | | |
| Test | ment | Ink | agent per unit | per unit area | | Image | Fixabil- | Tex- | friction | Washing | |
| No. | liquid No. | No. | area [g/m²] | [g/m²] | X1/Y1 | quality | ity | ture | fastness | fastness | Remarks |
| 24 | 1-9 | 2-5 | 0.15 | 0 | — | D | E | Δ | 1 | x | Comparative example |
| 25 | 1-9 | 2-6 | 0.15 | 0 | — | D | C | Δ | 2 | x | Comparative example |
| 26 | 1-9 | 2-7 | 0.15 | 0 | — | D | D | Δ | 1 | x | Comparative example |
| 27 | 1-9 | 2-8 | 0.15 | 0 | — | D | D | ∘ | 2 | x | Comparative example |
| 28 | 1-9 | 2-9 | 0.15 | 0 | — | D | D | ∘ | 2 | x | Comparative example |
| 29 | 1-9 | 2-10 | 0.15 | 0 | — | D | E | Δ | 1 | x | Comparative example |
| 30 | 1-9 | 2-11 | 0.9 | 0 | — | D | A | x | 2 | x | Comparative example |
| 31 | 1-9 | 2-12 | 0.9 | 0 | — | D | B | x | 2 | x | Comparative example |
| 32 | 1-9 | 2-13 | 0.15 | 0.405 | 0.37 | C | C | Δ | 3 | Δ | Example |
| 33 | 1-9 | 2-14 | 0.15 | 0.405 | 0.37 | B | A | Δ | 5 | ∘ | Example |
| 34 | 1-9 | 2-15 | 0.15 | 0.405 | 0.37 | C | B | ∘ | 3 | ∘ | Example |
| 35 | 1-9 | 2-16 | 0.15 | 0.405 | 0.37 | C | B | ∘ | 4 | Δ | Example |
| 36 | 1-9 | 2-17 | 0.15 | 0.405 | 0.37 | B | A | ∘ | 4 | ∘ | Example |
| 37 | 1-9 | 2-18 | 0.15 | 0.405 | 0.37 | B | C | Δ | 3 | Δ | Example |
| 38 | 1-9 | 2-19 | 0.15 | 0.405 | 0.37 | B | B | Δ | 4 | Δ | Example |
| 39 | 1-9 | 2-20 | 0.15 | 0.405 | 0.37 | A | A | Δ | 5 | ∘ | Example |
| 40 | 1-9 | 2-21 | 0.15 | 0.405 | 0.37 | B | A | ∘ | 4 | ∘ | Example |
| 41 | 1-9 | 2-22 | 0.15 | 0.405 | 0.37 | B | A | ∘ | 5 | ∘ | Example |
| 42 | 1-9 | 2-23 | 0.15 | 0.405 | 0.37 | A | A | ∘ | 5 | ∘ | Example |
| 43 | 1-9 | 2-24 | 0.15 | 0.405 | 0.37 | B | B | Δ | 4 | Δ | Example |
| 44 | 1-9 | 2-25 | 0.90 | 0.405 | 2.22 | A | A | Δ | 5 | ∘ | Example |
| 45 | 1-9 | 2-26 | 0.90 | 0.405 | 2.22 | A | A | Δ | 5 | ∘ | Example |
| 46 | 1-2 | 2-27 | 0.15 | 0 | — | D | C | Δ | 2 | Δ | Comparative example |
| 47 | 1-5 | 2-28 | 0.15 | 0 | — | D | D | ∘ | 2 | x | Comparative example |
| 48 | 1-2 | 2-29 | 0.15 | 0.405 | 0.37 | C | A | Δ | 5 | ∘ | Example |
| 49 | 1-5 | 2-30 | 0.15 | 0.405 | 0.37 | B | A | ∘ | 4 | ∘ | Example |
| 50 | 1-2 | 2-31 | 0.15 | 0.405 | 0.37 | B | A | Δ | 5 | ∘ | Example |
| 51 | 1-5 | 2-32 | 0.15 | 0.405 | 0.37 | B | A | ∘ | 5 | ∘ | Example |

Furthermore, some of the inks prepared above were evaluated for storage stability and ejection stability.

### (Storage Stability)

Each of the inks 2-1 to 2-3 and 2-5 to 2-26 was placed in a polyethylene terephthalate container, which was then hermetically sealed and stored in a thermostatic bath at 50° C. for 14 days. The viscosity and the dispersed particle size after storage were measured, and the storage stability was evaluated based on the rate of change in the viscosity and the dispersed particle size after the storage with respect to the viscosity and the dispersed particle size before the storage. The viscosity was measured with a R100 viscosimeter (manufactured by Toki Sangyo Co., Ltd) under the conditions of 25° C. and a cone revolution of 20 to 100 rpm. The dispersed particle size was determined by measuring the dispersed particle size (Z-average) of the polymer particles in a dispersion liquid of polymer particles with a Zataizer NanoS90 manufactured by Melvern. The rate of change in spectral absorption was calculated by the following formula, and the storage stability was evaluated based on the following evaluation criteria.

Rate of change (%)=100×{absolute value of [(measurement value after storage)−(measurement value before storage)]}/(measurement value before storage)

A: The rate of change in both viscosity and dispersed particle size is less than 10%.

B: The rate of change in either viscosity or dispersed particle size is 10% or more.

C: The rate of change in both viscosity and dispersed particle size is 10% or more.

### (Ejection Stability)

Each of the inks 2-1, 2-2, and 2-27 to 2-32 among the inks prepared above were ejected by a line system using a KM1024iMHE manufactured by Konica Minolta, Inc. under an ejection condition of a droplet ejection amount of 13 pL. After it was confirmed that the filling ink was ejected from all 60 nozzles at the start of ejection, the ink was continuously ejected for 60 minutes. Then, after the completion of the continuous ejection for 60 minute, the number of nozzles that were able to eject to the end (the number of ejecting nozzles after the completion of the continuous ejection for 60 minutes) was counted. The number of ejecting nozzles after completion of continuous ejection for 60 minutes was applied to the following evaluation criteria to evaluate the ejection property of the ink.

A: After 60 minutes of continuous ejection, the number of ejecting nozzles was 60 or more.

B: After 60 minutes of continuous ejection, the number of ejecting nozzles was 57 to 59.

C: After 60 minutes of continuous ejection, the number of ejecting nozzles was 54 to 56.

D: After 60 minutes of continuous ejection, the number of ejecting nozzles was 53 or less.

Table 6 shows the results of evaluation of the storage stability of the inks, and Table 7 shows the results of evaluation of the ejection stability of the inks.

TABLE 6

| Ink No | Storage stability |
|---|---|
| 2-1 | A |
| 2-2 | A |
| 2-3 | A |
| 2-5 | C |
| 2-6 | C |
| 2-7 | C |
| 2-8 | C |
| 2-9 | C |
| 2-10 | C |
| 2-11 | C |
| 2-12 | C |
| 2-13 | C |
| 2-14 | B |
| 2-15 | C |
| 2-16 | C |
| 2-17 | B |
| 2-18 | B |
| 2-19 | B |
| 2-20 | A |
| 2-21 | B |
| 2-22 | B |
| 2-23 | A |
| 2-24 | B |
| 2-25 | A |
| 2-26 | A |

TABLE 7

| Ink No | Ejection stability |
|---|---|
| 2-1 | A |
| 2-2 | A |
| 2-27 | D |
| 2-28 | D |
| 2-29 | C |
| 2-30 | C |
| 2-31 | B |
| 2-32 | B |

Regarding the evaluation of image formation, as shown in Table 4, the image formed products obtained in Tests 1 to 8, 24 to 31, 46, and 47 (comparative) failed to satisfy all of the acceptable levels of image quality, texture, wet friction color fastness, and washing fastness. In contrast, the image formed products obtained in Tests 9 to 23, 32 to 45, and 48 to 51 (the present invention) were able to satisfy all of the image quality, texture, wet friction color fastness, and washing fastness to acceptable levels.

From the above-described results, it is considered that by using the block copolymer as the pigment-dispersing agent, the pigment-dispersing agent is less likely to be peeled off from the pigment, the image quality can be improved, and furthermore, by crosslinking between the pigment-dispersing agent and the crosslinking agent, the wet friction color fastness and the washing fastness of the image formed product can be further enhanced.

In addition, from the comparison between Test 3 and Test 11, it is considered that, by using the block copolymer, crosslinking aggregation between the pigment dispersions can be made less likely to occur while maintaining the dispersibility in the aqueous solvent, and therefore, the crosslinking reaction uniformly proceeds, and the texture of the cloth is easily maintained.

From the comparison of Tests 9 to 14, it is found that the use of the epoxy compound (Test 10), the oxazoline compound (Test 12), and the isocyanate compound (Test 13) as the crosslinking agent not only forms a crosslinked structure with the pigment-dispersing agent, but also can satisfactorily crosslink with the hydrophilic functional groups contained in the fabric to form a higher-order crosslinked structure. Therefore, it is considered that the wet friction color fastness could be further enhanced.

As can be seen from the results of Tests 1 to 8, in the case of using a random copolymer as the pigment-dispersing agent, the use of an ink set including a crosslinking agent causes a problem of insufficient wetting and spreading and a reduction in image quality. On the other hand, as seen from the results of Tests 9 to 20, it was found that when a block copolymer was used as a pigment-dispersing agent, the image quality was enhanced also in the ink set containing a crosslinking agent. The reason is considered as follows. Since the block copolymer has high dispersibility of the pigment in the aqueous solvent, the pigment can be uniformly applied to the fabric. Thus, an image formed product having high image quality with high sharpness and little color unevenness can be obtained.

Furthermore, when Tests 15 to 20 are compared, the epoxy compound and the isocyanate compound have high compatibility with the water-soluble resin and the resin such as the aggregating agent, and do not tend to interfere with the wetting and spreading of the ink. Therefore, it is considered that the concentration unevenness of the pigment could be suppressed and more satisfactory image quality could be obtained.

Furthermore, the results of the storage stability indicate that the inks 2-1 to 2-3 in which no crosslinking agent was added to the ink have high storage stability regardless of whether the pigment-dispersing agent is a random copolymer or a block copolymer. Further, it is found that even when the crosslinking agent is added to the ink, when the block copolymer is used as the pigment-dispersing agent, thickening due to long-term storage can be prevented, and storage stability including ejection stability can be enhanced. The reason is considered as follows. In the block copolymer, a hydrophilic block that increases affinity to water and a hydrophobic block that adsorbs to a pigment are localized. When the pigment is dispersed in an aqueous solvent, the crosslinking agent tends to be present on the hydrophobic block side of the pigment-dispersing agent (inside of the pigment dispersion) because the crosslinking agent has hydrophobicity. Therefore, the crosslinking agent is less likely to be present on the hydrophilic block side of the pigment-dispersing agent (on the outer side of the pigment dispersion), and the hydrophilic block of the pigment-dispersing agent and the crosslinking agent are less likely to be crosslinked and aggregated. As a result, even when a crosslinking agent is added to the ink, thickening due to long-term storage is prevented, and storage stability is enhanced.

### INDUSTRIAL APPLICABILITY

According to the present invention, it is possible to provide an ink set for inkjet textile printing that can form an image having high wet friction color fastness and washing fastness while having satisfactory texture.

Although embodiments of the present invention have been described and illustrated in detail, the disclosed embodiments are made for purposes of illustration and example only and not limitation. The scope of the present invention should be interpreted by terms of the appended claims.

What is claimed is:

1. An ink set for inkjet textile printing, the ink set comprising an inkjet ink and at least one treatment liquid, wherein:
the inkjet ink includes a pigment, a pigment-dispersing agent, and a solvent;
the pigment-dispersing agent is a block copolymer including a hydrophilic block A and a hydrophobic block B;
at least one of the at least one treatment liquid and the inkjet ink includes a crosslinking agent;
the crosslinking agent includes at least one compound selected from the group consisting of a vinyl ether compound, an epoxy compound, a carbodiimide compound, an oxazoline compound, an isocyanate compound, and an aziridine compound.

2. The ink set for inkjet textile printing according to claim 1, wherein
the pigment-dispersing agent is an ABA-type block copolymer including two of the hydrophilic blocks A and one of the hydrophobic block B.

3. The ink set for inkjet textile printing according to claim 1, wherein:
the crosslinking agent is included at least in one of the at least one treatment liquid; and
a content of the crosslinking agent in the at least one treatment liquid is 0.1% by mass or more based on a total mass of the at least one treatment liquid.

4. The ink set for inkjet textile printing according to claim 3, wherein
a content of the crosslinking agent in the inkjet ink is 3.0% by mass or less based on a total mass of the inkjet ink.

5. An image forming method, comprising:
applying, to a surface of a fabric, a treatment liquid, and an inkjet ink by an inkjet method, wherein:
the inkjet ink includes a pigment, a pigment-dispersing agent, and a solvent;
the pigment-dispersing agent is a block copolymer including a hydrophilic block A and a hydrophobic block B;
at least one of the treatment liquid and the inkjet ink includes a crosslinking agent; and
the crosslinking agent includes at least one compound selected from the group consisting of a vinyl ether compound, an epoxy compound, a carbodiimide compound, an oxazoline compound, an isocyanate compound, and an aziridine compound.

6. The image forming method according to claim 5, wherein
a ratio of X1 g/m² to Y1 g/m² is in a range of 0.05 to 10, the ratio being X1/Y1, the X1 g/m² being an application amount of the crosslinking agent to be applied to the fabric per unit area, the Y1 g/m² being an application amount of the pigment-dispersing agent to be applied to the fabric per unit area.

7. An image formed product comprising:
a fabric; and
an image portion disposed on the fabric, wherein:
the image portion includes a pigment and a pigment-dispersing agent crosslinked by a crosslinking agent;
the pigment-dispersing agent is a block copolymer including a hydrophilic block A and a hydrophobic block B;
the crosslinking agent includes at least one compound selected from the group consisting of a vinyl ether compound, an epoxy compound, a carbodiimide compound, an oxazoline compound, an isocyanate compound, and an aziridine compound.

8. The image formed product according to claim 7, wherein
a ratio of X2 g/m² to Y2 g/m² is in a range of 0.05 to 10, the ratio being X2/Y2, the X2 g/m² being an application amount of the crosslinking agent included in the image portion per unit area, the Y2 g/m² being an application amount of the pigment-dispersing agent included in the image portion per unit area.
